(19) United States
(12) Patent Application Publication
(10) Pub. No.: US 2017/0132923 A1
(43) Pub. Date: May 11, 2017

(54) VEHICLE DATA PROCESSING SYSTEM AND METHOD

(71) Applicant: Leauto Intelligent Technology (BEIJING) Co. Ltd., Beijing (CN)

(72) Inventors: Dan Li, Bejing (CN); Yong Xu, Beijing (CN); Yu Zou, Beijing (CN); Wei Lin, Beijing (CN); Kunsheng Chen, Beijing (CN); Wenrui Li, Beijing (CN); Peng Liu, Beijing (CN)

(73) Assignee: Leauto Intelligent Technology (BEIJING) Co. Ltd., Beijing (CN)

(21) Appl. No.: 14/979,800

(22) Filed: Dec. 28, 2015

(30) Foreign Application Priority Data
Nov. 6, 2015 (CN) 201510752795.6

(51) Int. Cl. G08G 1/0967; B60R 1/00; H04N 7/18; H04L 29/06

(52) U.S. Cl. CPC G08G 1/0967; H04L 65/4076; B60R 1/00; H04N 7/183

(57) ABSTRACT

The present disclosure provides a vehicle data processing system and method, which may solve the problem of the prior arts. The system includes vehicle terminals and a fixed terminal, wherein the vehicle terminals include a first vehicle terminal and a second vehicle terminal; and the first vehicle terminal includes an acquisition module, a first vehicle and peripheral device communication module, and a first processor. The acquisition module of the first vehicle terminal acquires data, the processor and the V2X communication module send a running data sharing packet, and a vehicle or a roadside terminal in the vehicular temporary network can receive the broadcast message through the V2X communication module, thus acquiring the running data sharing packet; and the vehicle or the roadside terminal can also share the running data sharing packet to the vehicular temporary network again, so that the front road condition information is acquired in time.

### CROSS-REFERENCE TO RELATED APPLICATIONS

Pursuant to 35 U.S.C. §119 and the Paris Convention Treaty, this application claims the benefit of Chinese Patent Application No. 201510752795.6 filed on Nov. 6, 2015, entitled “vehicle data processing system and method”, the contents of which are incorporated herein by reference.

### FIELD OF TECHNOLOGY

The present disclosure relates to the technical field of vehicles, and particularly relates to a vehicle data processing system and a vehicle data processing method.

### BACKGROUND

At present, vehicular forward looking systems are mainly applied to two aspects, i.e. travelling recorders and travelling early warning systems. A travelling recorder is used for recording the road condition in front of a vehicle during running of the vehicle, so as to record and analyze an accident when it occurs. A travelling early warning system is represented by Mobil eye, and has driving assistance early warning functions of pedestrian detection, lane departure and the like.

The above-mentioned vehicular forward looking system serves the vehicle on the basis of the visual angle of the vehicle. However, when the vehicle actually runs on a road, the road condition is generally relatively complex, e.g. sudden traffic accidents, invisible ramps, invisible tortuous roads and the like still belong to visual blind areas for drivers, the specific road condition is difficult to learn when the vehicle is not driven to the corresponding position, and the vehicle cannot pre judgesome complex conditions.

Therefore, a technical problem to be urgently solved by those skilled in the art at present is to propose a vehicle data processing method for acquiring the front road condition in time.

### SUMMARY

One objective of the embodiments of the present disclosure is to provide a vehicle data processing system and method, which may solve the problem that a running vehicle cannot acquire the front road condition in time in the prior art.

To achieve the objective, one embodiment of the present disclosure provides a vehicle data processing system, including vehicle terminals and a fixed terminal, wherein the vehicle terminals include a first vehicle terminal and a second vehicle terminal; the first vehicle terminal includes an acquisition module, a first vehicle and peripheral device communication module, and a first processor; wherein the acquisition module is used for acquiring current road condition data when detecting that the current road condition accords with a sharing condition; the first processor is used for generating a running data sharing packet according to the road condition data; the first vehicle and peripheral device communication module is used for sharing the running data sharing packet to a vehicular temporary network as a first broadcast message; the second vehicle terminal includes a second vehicle and peripheral device communication module; the second vehicle and peripheral device communication module is used for receiving the first broadcast message, and sharing the running data sharing packet in the first broadcast message to the vehicular temporary network; the fixed terminal includes a third vehicle and peripheral device communication module; and the third vehicle and peripheral device communication module is used for receiving the first broadcast message, and sharing the running data sharing packet in the first broadcast message to the vehicular temporary network.

Another embodiment of the present disclosure provides a vehicle data processing method, including: acquiring current road condition data by a first vehicle terminal when detecting that the current road condition accords with a sharing condition; generating a running data sharing packet by adopting the road condition data, and sharing the running data sharing packet to a vehicular temporary network as a first broadcast message by the first vehicle terminal; and sharing the running data sharing packet by a fixed terminal and a second vehicle terminal which are connected to the vehicular temporary network after receiving the first broadcast message.

According to the vehicle data processing system and method provided by the embodiments of the present disclosure, in the embodiments of the present disclosure, the acquisition module of the first vehicle terminal acquires data, the processor and the V2X communication module send the running data sharing packet in the form of a broadcast message, and a vehicle or a roadside terminal in the vehicular temporary network can receive the broadcast message through the V2X communication module, thus acquiring the running data sharing packet; and the vehicle or the roadside terminal can also share the running data sharing packet to the vehicular temporary network again, so that all vehicles running on the road can receive the running data sharing packet through the V2X communication module and then acquire front road condition information in time.

### BRIEF DESCRIPTION OF THE DRAWINGS

In order to describe the technical solutions in the embodiments of the present disclosure or in the prior art more clearly, a simple introduction to the accompanying drawings which are needed in the description of the embodiments or the prior art is given below. Apparently, the accompanying drawings in the description below are merely some of the embodiments of the present disclosure, based on which other drawings may be obtained by those of ordinary skill in the art without any creative effort.

FIG. 1 is a structural block diagram of a vehicle data processing system of one embodiment of the present disclosure;

FIG. 2 is a step flow diagram of a vehicle data processing method of one embodiment of the present disclosure;

FIG. 3 is a structural block diagram of a vehicle data processing system of another embodiment of the present disclosure;

FIG. 4 is a schematic diagram of V2X communication of one embodiment of the present disclosure;

FIG. 5 is a schematic diagram of V2X communication of another embodiment of the present disclosure;

FIG. 6 is a step flow diagram of a vehicle data processing method of another embodiment of the present disclosure.

### DESCRIPTION OF THE EMBODIMENTS

To achieve the objective, technical solutions and advantages of the embodiments of the present disclosure clearer, a clear and complete description of the technical solutions in the present disclosure will be given below, in conjunction with the accompanying drawings in the embodiments of the present disclosure. Apparently, the embodiments described below are part, but not all, of the embodiments of the present disclosure. All of other embodiments, obtained by those of ordinary skill in the art based on the embodiments in the present disclosure without any creative effort, fall into the protection scope of the present disclosure.

During running of a vehicle, the front road condition is generally predicted through a vehicular forward looking system in the prior art, whereas the rear vehicle cannot acquire the front road condition information in time, e.g. an invisible road condition cannot be accurately predicted. Thus, no matter the front vehicle or the rear vehicle acquiring the front road condition (e.g. bump, pit, jam, accumulated water, a large amount of large-sized transport vehicles and the like) in time can benefit the rear vehicle to make a running route planning or a driving operation (e.g. braking, overtaking and the like) as early as possible. Accordingly, the embodiments of the present disclosure provide a vehicle data processing method and a vehicle data processing system, wherein the vehicle can acquire road condition data in the running process, establish a vehicular temporary network on the basis of V2X (Vehicle-to-X) communication technology, and notify a fixed terminal or a vehicle terminal installed on other vehicle in the vehicular temporary network of the road condition data, so as to acquire the front road condition in time.

### Embodiment 1

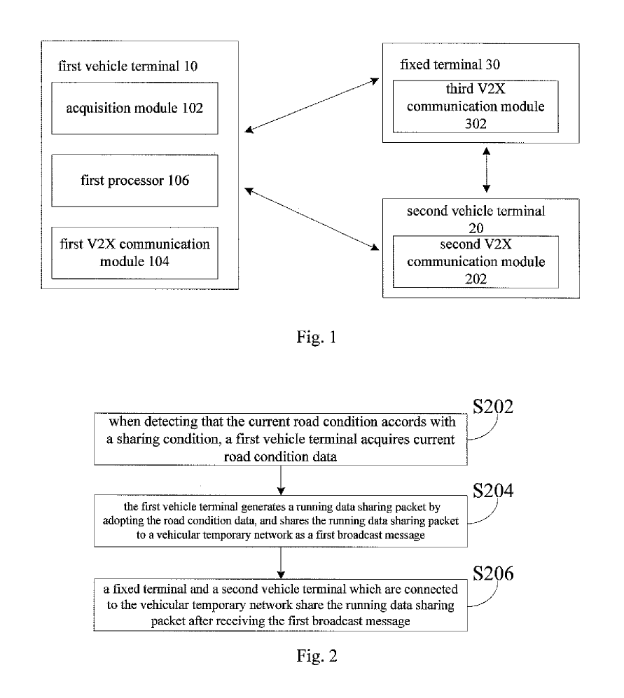

See FIG. 1, which shows a structural block diagram of a vehicle data processing system of an embodiment of the present disclosure. The system specifically may include:

vehicle terminals and a fixed terminal 30, wherein the vehicle terminals include a first vehicle terminal 10 and a second vehicle terminal 20.

Specifically, the first vehicle terminal 10 includes an acquisition module 102 and a first vehicle and peripheral device (Vehicle-to-X, V2X) communication module 104 which are respectively connected with a first processor 106; wherein the acquisition module 102 is used for acquiring current road condition data when detecting that the current road condition accords with a sharing condition; the first processor 106 is used for generating a running data sharing packet according to the road condition data; and the first V2X communication module 104 is used for sharing the running data sharing packet to a vehicular temporary network as a first broadcast message.

The second vehicle terminal 20 includes a second V2X communication module 202; wherein the second V2X communication module 202 is used for receiving the first broadcast message, and sharing the running data sharing packet in the first broadcast message to the vehicular temporary network.

The fixed terminal 30 includes a third V2X communication module 302; wherein the third V2X communication module 302 is used for receiving the first broadcast message, and sharing the running data sharing packet in the first broadcast message to the vehicular temporary network.

According to the vehicle data processing system provided by the embodiment of the present disclosure, vehicles running on a road can interact for the front road condition on the basis of V2X communication through vehicle terminals and a roadside fixed terminal.

Specifically, the first V2X communication module 104 enables a vehicle terminal of a running vehicle within a certain distance threshold range and a roadside fixed terminal to establish a temporary network on the basis of V2X technology, for example, a vehicle within 300-1000 meters away from the roadside fixed terminal and the roadside fixed terminal establish a temporary network, for another example, vehicle terminals of running vehicles within 300-1000 meters may also establish a temporary network.

In this case, V2X indicates communication between a vehicle and a peripheral device, i.e. vehicle-and-outside information exchange, thus, X includes a vehicle terminal, a roadside fixed terminal, a server and the like, and V2X enables vehicles, a vehicle and a base station, or base stations to communicate with each other. Thus, such a series of traffic information as real-time road condition, road information, pedestrian information and the like may be acquired, to improve the driving safety, reduce jam, improve the traffic efficiency, provide vehicle-mounted amusement information and the like. A vehicular temporary network may be established during communication based on the V2X technology, terminals may wirelessly communicate with each other through the V2X communication module, and the wireless communication technology follows the IEEE802.11P protocol. In this case, all V2X communication modules within a certain distance threshold (e.g. 300-1000 meters) range may establish a temporary network, and each V2X communication module can carry out wireless communication and share the running data sharing packet. For example, the designed transmission distance is 300-1000 m, the transmission rate is 3M-27 Mbps, and then V2X is mainly applied in the fields of intelligent traffic and driving active safety, to reduce traffic accidents and improve the traffic efficiency. Compared with 3G/LTE, V2X communication has the advantages that the transmission instantaneity is high, a base station is needed, and operator traffic and fee are not required.

After the temporary network is established, the running vehicles in the temporary network may interact with each other, or the running vehicles not in the same temporary network may also interact with each other through a fixed terminal; the acquisition module 102 of the first vehicle terminal 10 detects the running road condition in real time, and when detecting that the front road condition accords with a sharing condition, the acquisition module 102 takes charge of data acquisition on the front road condition to obtain road condition data, wherein the preset sharing condition includes that the front road condition forces running vehicles to stop or slow down; then the acquisition module 102 sends the obtained road condition data to the first processor 106, and the first processor 106 processes the road condition data to obtain a running data sharing packet, wherein the running data sharing packet includes image data and position data of the front road condition; the first processor 106 sends the generated running data sharing packet to the first V2X communication module 104, and the first V2X communication module 104 generates a first broadcast message according to the running data sharing packet and shares the first broadcast message to a vehicular temporary network through wireless communication.

All the second vehicle terminals 20 in the established vehicular temporary network can acquire the first broadcast message send by the first V2X communication module 104; after receiving the first broadcast message, the second vehicle terminal 20 analyzes the first broadcast message to obtain the running data sharing packet, and then the second vehicle terminal 20 shares the running data sharing packet to the vehicular temporary network of the second vehicle through the second V2X communication module 202.

The first vehicle terminal 10 can also send the first broadcast message to the roadside fixed terminal 30 in the vehicular temporary network, wherein the third V2X communication module 302 in the roadside fixed terminal 30 receives the first broadcast message sent by the first vehicle terminal 10, and then analyzes the first broadcast message to obtain the running data sharing packet after receiving the first broadcast message, and the third V2X communication module 302 shares the running data sharing packet to the vehicular temporary network of the third V2X communication module 302.

See FIG. 2, which shows a step flow diagram of a vehicle data processing method of an embodiment of the present disclosure. The method specifically may include the following steps.

Step S202, when detecting that the current road condition accords with a sharing condition, a first vehicle terminal acquires current road condition data.

The sharing condition is preset in the embodiment of the present disclosure, wherein the preset sharing condition includes that the front road condition forces running vehicles to stop or slow down; and during running of vehicles, when the first vehicle terminal of the first vehicle detects that the current road condition accords with the sharing condition, the acquisition module acquires front road condition data of the current road condition.

Step S204, the first vehicle terminal generates a running data sharing packet by adopting the road condition data, and shares the running data sharing packet to a vehicular temporary network as a first broadcast message.

During running of vehicles, the vehicle terminal of a running vehicle establishes a vehicular temporary network with a peripheral device within a certain distance threshold range (e.g. 300-1000 meters) through the V2X communication module, wherein the peripheral device includes other running vehicle or a roadside fixed terminal in the temporary network. For example, a vehicle within 300-1000 meters away from the roadside fixed terminal and the roadside fixed terminal establish a temporary network; for another example, vehicle terminals of running vehicles within 300-1000 meters may also establish a temporary network.

In this case, V2X indicates communication between a vehicle and a peripheral device; X includes a vehicle terminal, a roadside fixed terminal, a server and the like; and after the temporary network is established, each terminal may establish wireless communication.

The first vehicle terminal processes the acquired road condition data, e.g. including the steps of image recognition, positioning and the like, to obtain a running data sharing packet; the V2X communication module in the first vehicle terminal establishes a vehicular temporary network within a threshold range; the processor processes the running data packet to obtain a first broadcast message; and the V2X communication module shares the first broadcast message to the vehicular temporary network of the first vehicle terminal.

Step S206, a fixed terminal and a second vehicle terminal which are connected to the vehicular temporary network share the running data sharing packet after receiving the first broadcast message.

The fixed terminal and the second vehicle terminal which are connected to the vehicular temporary network receive the running data sharing packet in the form of the first broadcast message, and after receiving the first broadcast message, may also process the first broadcast message to obtain the running data sharing packet, and share the running data sharing packet to a roadside fixed terminal or the vehicular temporary network of the second vehicle terminal.

In the embodiment of the present disclosure, the acquisition module of the first vehicle terminal acquires data, the processor and the V2X communication module send the running data sharing packet in the form of a broadcast message, and a vehicle or a roadside terminal in the vehicular temporary network can receive the broadcast message through the V2X communication module, thus acquiring the running data sharing packet; and the vehicle or the roadside terminal can also share the running data sharing packet to the vehicular temporary network again, so that all vehicles running on the road can receive the running data sharing packet through the V2X communication module and then acquire front road condition information in time.

### Embodiment 2

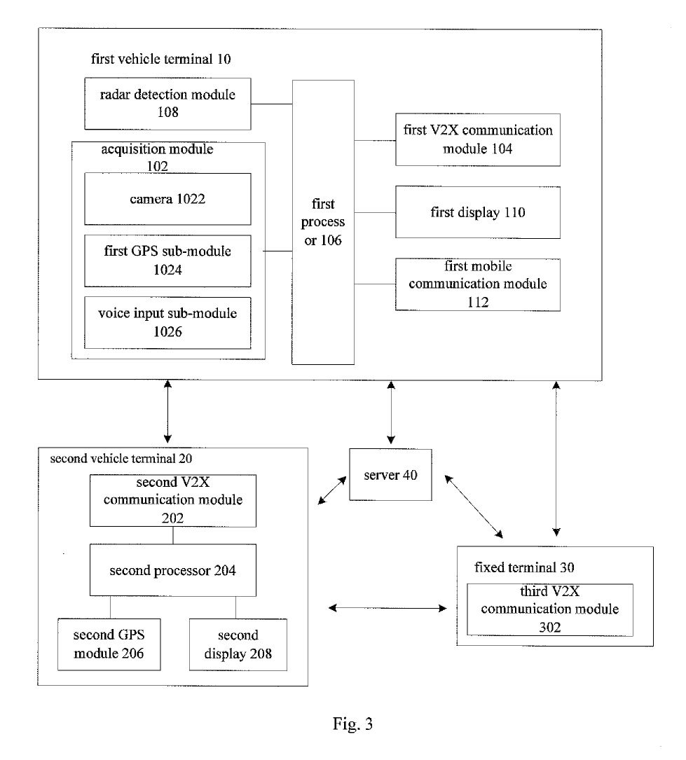

Refer to FIG. 3, which shows a structural block diagram of a vehicle data processing system of another embodiment of the present disclosure. The system specifically may include:

vehicle terminals, a fixed terminal 30 and a server 40, wherein the vehicle terminals include a first vehicle terminal 10 and a second vehicle terminal 20.

Specifically, the first vehicle terminal 10 includes an acquisition module 102, a first V2X communication module 104, a radar detection module 108, a first display 110 and a first mobile communication module 112 which are respectively connected with a first processor 106; wherein the acquisition module 102 includes a camera 1022, a first GPS sub-module 1024 and a voice input sub-module 1026.

Specifically, the radar detection module 108 is used for detecting the front road condition in real time, detecting whether the current road condition accords with a sharing condition, and triggering the acquisition module to acquire road condition data when detecting that the current road condition accords with the sharing condition; the camera 1022 is used for shooting front road condition picture data as road condition data; the first GPS (Global Positioning System) sub-module 1024 is used for acquiring current vehicle position data as road condition position data, and adding the road condition position data to the road condition data; the voice input sub-module 1026 is used for inputting voice data to generate road condition audio data, and adding the road condition audio data to the road condition data; the first processor 106 is used for generating a running data sharing packet according to the road condition data; the first V2X communication module is used for sharing the running data sharing packet to a vehicular temporary network as a first broadcast message; the first processor 106 is further used for adjusting running route information according to the road condition data to obtain adjusted running route information; the first display 110 is used for displaying the road condition picture data and displaying the adjusted running route information; and the first mobile communication module 112 is used for generating network data according to the running data sharing packet, and uploading the network data to the server 40 through a mobile network.

According to the vehicle data processing system provided by the embodiment of the present disclosure, vehicles running on a road can interact for the front road condition on the basis of V2X communication through vehicle terminals and a roadside fixed terminal.

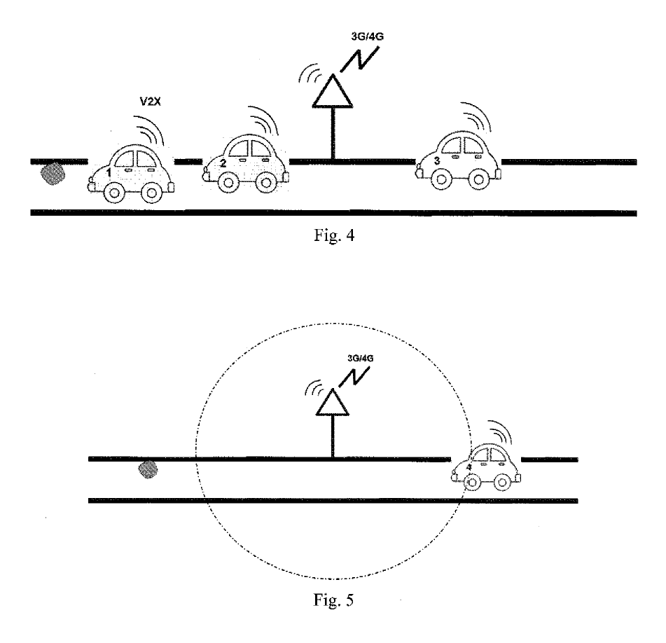

After the temporary network is established, as shown in FIG. 4, the running vehicles in the temporary network may interact with each other, or the running vehicles not in the same temporary network may also interact with each other through a fixed terminal. The radar detection module 108 of the first vehicle terminal 10 detects the front road condition in real time, and triggers the acquisition module to start when the radar detection module 108 detects that the current road condition accords with the sharing condition, wherein the preset sharing condition includes that the front road condition forces running vehicles to stop or slow down. For example, the vehicle detects such an obstacle as falling rock and the like in front, the volume of the obstacle reaches a preset threshold, e.g., the diameter exceeds 30 CM, and then it is determined that the obstacle hinders advancing of the vehicle and it is determined that the sharing condition is met. In this embodiment, radar is electronic equipment for detecting an object with electromagnetic wave. The radar emits electromagnetic wave to irradiate the object and receives echo thereof, thus acquiring such information as distance from the object to the electromagnetic wave emission point, distance change rate (radial speed), direction, height and the like.

The radar detection module 108 triggers the acquisition module 102 to acquire data of the front road condition, wherein the camera 1022 in the acquisition module 102 may be used to acquire picture data of the front road condition, namely the camera 1022 shoots a picture of a complex road condition, e.g., a large pit, large-area accumulated water or large-sized foreign matters on the ground, etc., and the picture data is used as one of the road condition data. The first GPS sub-module 1024 in the acquisition module 102 may be further adopted for positioning to acquire specific geographical position information of the problematic road condition as road condition position data, and add the road condition position data to the road condition data. The voice input unit sub-module 1026 in the acquisition module 102 may further record audio data, e.g., when a user discovers an event and the like for reminding other users in the road condition, the voice input unit sub-module 1026 may be adopted to input audio data, e.g., describe specific information and the like in the picture data, the audio data is used as road condition audio data, and the road condition audio data is added to the road condition data. Thus, the road condition data includes picture data and road condition position data, and may further include road condition audio data.

The first processor 106 processes the road condition data to obtain a running data sharing packet, wherein the running data sharing packet includes picture data, road condition position data, road condition audio data and the like; the first processor 106 sends the generated running data sharing packet to the first V2X communication module 104; and the first V2X communication module 104 generates a first broadcast message according to the running data sharing packet, and shares the first broadcast message to a vehicular temporary network through wireless communication.

In this embodiment, the road condition data not only can be shared on the basis of V2X communication technology, but also can assist a vehicle in planning a subsequent running route. That is, the first processor 106 may further search the running route of the current vehicle, further determine whether the running route needs to be adjusted according to the front road condition information determined from the road condition data, and if so, adjust the running route information according to the front road condition information to obtain adjusted running route information, e.g., changing the route, rounding or slowing down, etc. The first display 110 may display the front road condition picture data, and display the adjusted running route information and the like for a user.

In this embodiment, the first mobile communication module 112 may generate network data according to the running data sharing packet, and upload the network data to the server 40 through a mobile network, wherein the first mobile communication module may include a 3G/4G communication module. After receiving the running data sharing packet, the server 40 may process the specific road condition, e.g., recognizing the road condition through the technology of image recognition and the like, determining whether the road condition needs to be processed, e.g., dispatching a person for repair and the like.

The second vehicle terminal 20 includes a second V2X communication module 202, a second GPS module 206 and a second display 208 which are respectively connected with a second processor 204.

Specifically, the second V2X communication module 202 is used for acquiring the running data sharing packet from the first broadcast message, generating a second broadcast message according to the running data sharing packet, and sharing the second broadcast message to the vehicular temporary network; the second GPS module 206 is used for acquiring current vehicle position data; the second processor 204 is used for acquiring the road condition position data from the road condition data, marking the road condition position data and the current vehicle position data into map data to obtain front road information generated from the marked map data, acquiring current running route information, and adjusting the running route information according to the road condition position data to obtain adjusted running route information; the second display 208 is used for displaying the marked map data and displaying the adjusted running route information; and the second V2X communication module 202 is further used for receiving a third broadcast message.

All the second vehicle terminals 20 in the vehicular temporary network established by the first vehicle terminal can acquire the first broadcast message send by the first V2X communication module 104; after receiving the first broadcast message, the second vehicle terminal 20 analyzes the first broadcast message to obtain the running data sharing packet, and shares the running data sharing packet to the vehicular temporary network of the second vehicle through the second V2X communication module 202.

The second GPS module 206 in the second vehicle terminal 20 determines the position information of the current vehicle in a map through GPS positioning; the second processor 204 analyzes the received running data sharing packet to obtain front road condition data including position data of the front road condition in the map, and marks the position data of the current vehicle and the position data of the front road condition in the map into the same map to obtain front road information generated from the marked map data; the second display 208 displays the front road information generated from the marked map data; the second processor 204 searches the running route of the current vehicle by recognizing and processing the front road information, and adjusts the running route information according to the front road information to obtain adjusted running route information, e.g. rounding or slowing down and the like; and the second display 208 displays the adjusted miming route information.

When the fixed terminal 30 and the second vehicle terminal 20 are in the same vehicular temporary network, the second V2X communication module 202 in the second vehicle terminal 20 may further receive a third broadcast message in the vehicular temporary network of the fixed terminal 30.

Preferably, the second vehicle terminal may further include a second mobile communication module, which is used for generating network data according to the running data sharing packet and uploading the network data to the server 40 through a mobile network.

The fixed terminal 30 includes a third V2X communication module 302; wherein the third V2X communication module 302 is used for receiving the first broadcast message, and sharing the running data sharing packet in the first broadcast message to the vehicular temporary network; and the third V2X communication module 302 is further used for receiving the second broadcast message.

The first vehicle terminal 10 may further send the first broadcast message to the roadside fixed terminal 30 in the vehicular temporary network, wherein the third V2X communication module 302 in the roadside fixed terminal 30 receives the first broadcast message sent by the first vehicle terminal 10, and then analyzes the first broadcast message to obtain the running data sharing packet, and the third V2X communication module 302 shares the running data sharing packet to the vehicular temporary network of the third V2X communication module 302.

When the fixed terminal 30 and the second vehicle terminal 20 are in the same vehicular temporary network, the fixed terminal 30 may receive the second broadcast message sent by the vehicular temporary network of the second vehicle terminal 20.

Preferably, the fixed terminal 30 may further include a third communication module, which is used for generating network data according to the running data sharing packet and uploading the network data to the server 40 through a mobile network.

The server 40 is used for processing the road condition data and feeding back the processing result to the first vehicle terminal 10, the second vehicle terminal 20 and the fixed terminal 30.

The server 40 is used for receiving the running data sharing packet from the first vehicle terminal 10, the second vehicle terminal 20 and the fixed terminal 30, generating network data, processing the network data, and feeding back the processing result to the first vehicle terminal 10, the second vehicle terminal 20 and the fixed terminal 30.

Thus, after the roadside fixed terminal device and the second vehicle terminal receive the running data sharing packet, the 3G/4G communication module may send the sharing packet to the background server of a relative maintenance or management department, so that a background person can analyze and judge the sharing packet; and if the terminal receives the sharing packet for more than three times within 10 min, it may also send an alarm signal to the background to prompt the person of processing in time when sending the sharing packet to the background. The background person analyzes and judges the real road condition according to the running data sharing packet and makes corresponding processing, e.g., dispatching a maintenance person in time, the background immediately returns voice broadcast to the third V2X communication module 302 of the roadside fixed terminal, and the third V2X communication module 302 broadcasts through the player to prompt the vehicles passing the road section of rounding carefully and the like (if the roadside fixed terminal module has an electronic screen, the display function may also be realized).

In addition, if the traffic flow of a road is relatively low, when the abnormal road condition detected by the front vehicle is shared through V2X, because no vehicle passes within a valid range, the roadside fixed terminal device may continuously broadcast for a certain period of time after receiving the running data sharing packet, e.g. 5 minutes (the time may be appropriately shortened or prolonged according to rugged mountain roads or other special roads or according to nights or days), thus ensuring that the rear vehicles far from the front vehicle can still receive the running data sharing packet. That is, as shown in FIG. 5, the rear vehicles far from the front vehicle can receive the front road condition information as long as running to the valid V2X communication range of the roadside terminal within the valid time, i.e. the vehicular temporary network.

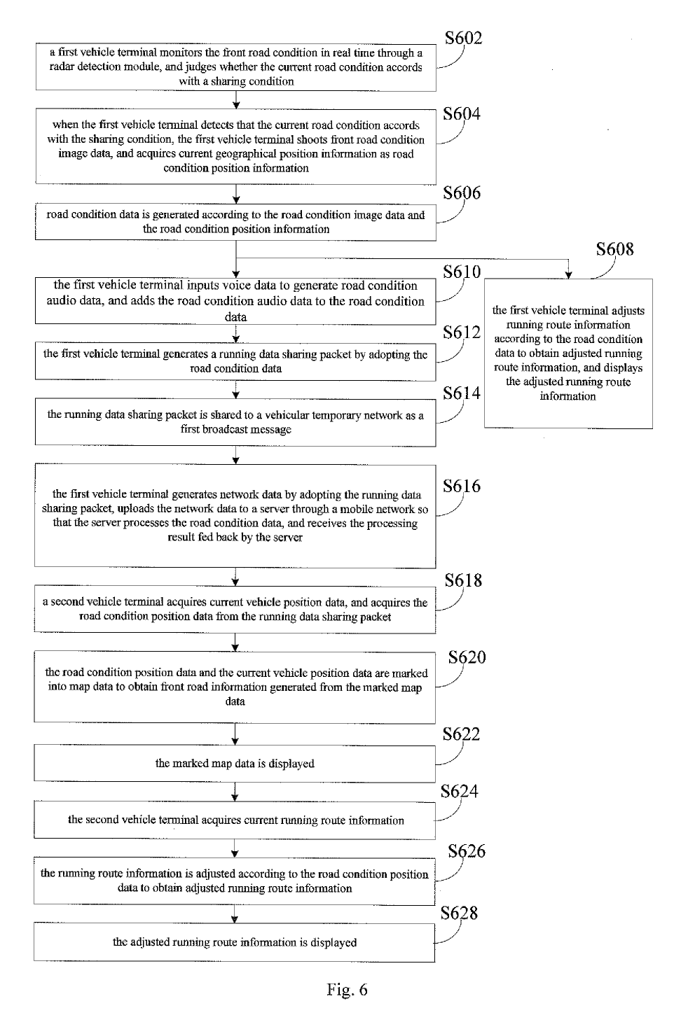

Refer to FIG. 6, which shows a step flow diagram of a vehicle data processing method of another embodiment of the present disclosure. The method specifically may include the following steps.

Step S602, a first vehicle terminal monitors the front road condition in real time through a radar detection module, and judges whether the current road condition accords with a sharing condition.

According to the vehicle data processing method provided by the embodiment of the present disclosure, vehicles running on a road can interact for the front road condition on the basis of V2X communication through vehicle terminals and a roadside fixed terminal.

During running of vehicles, the vehicle terminal of a running vehicle establishes a vehicular temporary network with a peripheral device within a certain distance threshold range (e.g. 300-1000 meters) through the V2X communication module, wherein the peripheral device includes other running vehicle or a roadside fixed terminal in the temporary network. For example, a vehicle within 300-1000 meters away from the roadside fixed terminal and the roadside fixed terminal establish a temporary network; for another example, vehicle terminals of running vehicles within 300-1000 meters may also establish a temporary network.

After the temporary network is established, the running vehicles in the temporary network may interact with each other, or the running vehicles not in the same temporary network may also interact with each other through a fixed terminal The radar detection module of the first vehicle terminal detects the front road condition in real time, and presets the sharing condition, wherein the preset sharing condition includes that the front road condition forces running vehicles to stop or slow down.

Step S604, when the first vehicle terminal detects that the current road condition accords with the sharing condition, the first vehicle terminal shoots front road condition image data, and acquires current geographical position information as road condition position information.

When the radar detection module detects that the front road condition accords with the sharing condition, it triggers the acquisition module to start, and the acquisition module acquires data of the front road condition, wherein the camera in the acquisition module acquires picture data of the front road condition, namely shoots a picture, and the picture data is used as road condition data; and the first GPS sub-module in the acquisition module processes the image data, and takes the position data in the road condition map of the picture as road condition position information through positioning.

Step S606, road condition data is generated according to the road condition image data and the road condition position information.

Road condition data is generated according to the image data shot by the camera and the road condition position information positioned by the first GPS sub-module.

Step S608, the first vehicle terminal adjusts running route information according to the road condition data to obtain adjusted running route information, and displays the adjusted running route information.

According to the road condition data, the first vehicle terminal adjusts running route information through a map, e.g., rounding or slowing down and the like, to obtain adjusted running route information, and a display displays the adjusted running route information.

Step S610, the first vehicle terminal inputs voice data to generate road condition audio data, and adds the road condition audio data to the road condition data.

The voice input unit sub-module in the acquisition module inputs audio data through voice for describing specific information in the picture data, takes the audio data as road condition audio data, and adds the road condition audio data to the road condition data; at the moment, the road condition data includes picture data, road condition position data and road condition audio data.

Step 612, the first vehicle terminal generates a running data sharing packet by adopting the road condition data.

Step S614, the running data sharing packet is shared to a vehicular temporary network as a first broadcast message.

The first processor processes the road condition data to obtain a running data sharing packet, wherein the running data sharing packet includes picture data, road condition position data and road condition audio data; the first processor sends the generated running data sharing packet to the first V2X communication module; and the first V2X communication module generates a first broadcast message according to the running data sharing packet, and shares the first broadcast message to a vehicular temporary network through wireless communication.

Step S616, the first vehicle terminal generates network data by adopting the running data sharing packet, uploads the network data to a server through a mobile network so that the server processes the road condition data, and receives the processing result fed back by the server.

The first mobile communication module is used for generating network data according to the running data sharing packet, and uploading the network data to a server through a mobile network, wherein the first mobile communication module may include a 3G/4G communication module; and the server receives the running data sharing packet, generates network data, processes the network data, and feeds back the processing result to the first vehicle terminal.

Step S618, a second vehicle terminal acquires current vehicle position data, and acquires the road condition position data from the running data sharing packet.

Step S620, the road condition position data and the current vehicle position data are marked into map data to obtain front road information generated from the marked map data.

Step S622, the marked map data is displayed.

All the second vehicle terminals in the vehicular temporary network established by the first vehicle terminal can acquire the first broadcast message send by the first V2X communication module; after receiving the first broadcast message, the second vehicle terminal analyzes the first broadcast message to obtain the running data sharing packet.

The second GPS module in the second vehicle terminal determines the position information of the current vehicle in a map through GPS positioning; the second processor analyzes the received running data sharing packet to obtain front road condition data including position data of the front road condition in the map, and marks the position data of the current vehicle and the position data of the front road condition in the map into the same map to obtain front road information generated from the marked map data; and the second display displays the front road information generated from the marked map data.

Step S624, the second vehicle terminal acquires current running route information.

Step S626, the running route information is adjusted according to the road condition position data to obtain adjusted running route information.

Step S628, the adjusted running route information is displayed.

The second vehicle terminal acquires current running route information through GPS positioning, searches the running route of the current vehicle, and adjusts the running route information according to the front road information to obtain adjusted running route information, e.g. rounding or slowing down and the like; and the second display displays the adjusted running route information.

The vehicle terminal in this embodiment has the functions of GPS positioning, image acquisition, radar detection (or other detection), sound input, V2X communication and the like. When a vehicle detects that the front road is abnormal through radar or image recognition or other method, the acquisition module of the front vehicle may acquire an image of a complex road condition (e.g. a large pit, large-area accumulated water or large-sized foreign matters on the ground, etc.), and then the image is shared through the V2X communication module, so that the owner of the rear vehicle can make a pre-judgment, change the driving route or perform effective yielding. This share not only can be acquired by the vehicles within a V2X valid communication range (300-1000 m) of the current vehicle, but also can be acquired by rear vehicles within a certain time range when the road traffic flow is relatively low and even if the active sharing vehicle has gone far.

The front vehicle shares the special road condition to surrounding vehicles and a roadside fixed device in real time through the V2X communication module, and the vehicles within the valid V2X communication range may immediately acquire the complex road condition information and make a yielding pre-judgment. When a few vehicles are on the road and no vehicle is in the valid range, the roadside fixed device may continuously broadcast the acquired information for 5 min, for example, to ensure that rear vehicles may still acquire the special road condition information even if no vehicles are in front (e.g. at night), meanwhile, the fixed terminal may also send the information to the background of a relative maintenance or management department through a 3G/4G module thereof, so that background persons make a judgment and maintain the road in time to avoid road jam and accidents. (This scheme and the device are particularly suitable for night roads, mountain roads and the like where the traffic flow is relatively low.)

In the embodiment of the present disclosure, data is acquired through the acquisition module of the first vehicle terminal, the front road condition may also be described by adding voice and inputting audio data, and the front road condition is displayed by the display; the running data sharing packet is sent by the processor and the V2X communication module in the form of a broadcast message, and a vehicle or a roadside terminal in the vehicular temporary network can receive the broadcast message through the V2X communication module, thus acquiring the running data sharing packet; the vehicle or the roadside terminal can also share the running data sharing packet to the vehicular temporary network again, and a mobile communication module is added to each terminal, so that each terminal can send the running data sharing packet to the server through the mobile communication module, and the server makes corresponding feedback; in this way, all vehicles running on the road can receive the running data sharing packet or the feedback data sent by the server through the V2X communication module, thus acquiring front road condition information in time.

The device embodiments described above are only schematic, wherein the modules illustrated as separate components may be or may not be physically separated, and the components displayed as modules may be or may not be physical modules, that is to say, the components may be positioned at one place or may also be distributed on a plurality of network modules. The objectives of the solutions of the embodiments may be fulfilled by selecting part of or all of the modules according to actual needs. Those of ordinary skill in the art could understand and implement the embodiments without any creative effort.

It should be noted that, the method embodiments are expressed as combinations of a series of actions for the purpose of simple description, but those skilled in the art should learn that the embodiments of the present disclosure are not limited by the described action sequence, because some steps may adopt other sequence or be simultaneously performed according to the embodiments of the present disclosure. Secondly, those skilled in the art should also learn that, the embodiments descried in the specification all belong to preferred embodiments, and the involved actions are not always necessary for the embodiments of the present disclosure.

The embodiments in the specification are described progressively, the highlight of each embodiment is the difference from other embodiments, and the similar parts among the embodiments refer to one another.

It should be appreciated by those skilled in the art that the embodiments of the present disclosure may be provided as methods, devices or computer program products. Therefore, the embodiments of the present disclosure may adopt the form of complete hardware embodiments, complete software embodiments or embodiments of software and hardware in combination. Moreover, the embodiments of the present disclosure may adopt the form of computer program products implemented on one or more computer-useable storage media (including but not limited to a magnetic disk memory, a compact disc read-only memory (CD-ROM), an optimal memory and the like) including computer-usable program codes.

The embodiments of the present disclosure are described with reference to flow diagrams and/or block diagrams of the methods, terminal devices (systems) and computer program products according to the embodiments of the present disclosure. It should be understood that each flow and/or block in the flow diagrams and/or block diagrams and combination of flows and/or blocks in the flow diagrams and/or block diagrams may be implemented by computer program instructions. These computer program instructions may be supplied to a general computer, a dedicated computer, an embedded processor or a processor of other programmable data processing terminal device to produce a machine, so that a device for achieving functions designated in one or more flows of the flow diagrams and/or one or more blocks of the block diagrams is produced through the instructions executed by the computer or the processor of the other programmable data processing terminal device.

These computer program instructions may also be stored in a computer-readable memory capable of guiding the computer or the other programmable data processing terminal device to work in a specific mode, so as to generate a manufactured product including an instruction device through the instructions stored in the computer-readable memory, and the instruction device implements the functions designated in one or more flows of the flow diagrams and/or one or more blocks of the block diagrams.

These computer program instructions may also be loaded to the computer or the other programmable data processing terminal device, so that a series of operation steps are executed in the computer or the other programmable data processing terminal device to produce processing implemented by the computer, and the instructions executed in the computer or the other programmable data processing terminal device provide steps of implementing the functions designated in one or more flows of the flow diagrams and/or one or more blocks of the block diagrams.

Although the preferred embodiments of the present disclosure have been described, other changes and modifications could be made to these embodiments by those skilled in the art once they get the basic creative concepts. Accordingly, the appended claims are intended to be interpreted as covering the preferred embodiments and all the changes and modifications falling within the scope of the present disclosure.

Finally, it should also be noted that, in the description, such relation terms as first and second are merely used for distinguishing one entity or operation from the other entity or operation, rather than requiring or hinting that these entities or operations have any practical relation or sequence. Moreover, the terms “comprise”, “include” or any other variant are intended to cover non-exclusive inclusion, so that the processes, methods, articles or terminal devices including a series of factors not only include those factors, but also include other factors listed implicitly, or further include inherent factors of the processes, methods, articles or terminal devices. In the absence of more limitations, the factors defined by the statement “include one . . . ” do not exclude other identical factors in the processes, methods, articles or terminal devices including said factors.

The vehicle data processing system and the vehicle data processing method provided by the present disclosure are introduced in detail above, specific examples are applied in the description to illustrate the principle and embodiments of the present disclosure, and the above embodiments are merely used for illustrating the technical solutions of the present disclosure, rather than limiting the present disclosure; although the present disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to part of technical characteristics thereof; and these modifications or substitutions do not make the nature of the corresponding technical solutions depart from the spirit and scope of the technical solutions of the respective embodiments of the present disclosure.

1. A vehicle data processing system, comprising vehicle terminals and a fixed terminal, wherein the vehicle terminals comprise a first vehicle terminal and a second vehicle terminal;
the first vehicle terminal comprises an acquisition module, a first vehicle and peripheral device communication module, and a first processor; wherein the acquisition module is used for acquiring current road condition data when detecting that the current road condition accords with a sharing condition;
the first processor is used for generating a running data sharing packet according to the road condition data;
the first vehicle and peripheral device communication module is used for sharing the running data sharing packet to a vehicular temporary network as a first broadcast message;
the second vehicle terminal comprises a second vehicle and peripheral device communication module; the second vehicle and peripheral device communication module is used for receiving the first broadcast message, and sharing the running data sharing packet in the first broadcast message to the vehicular temporary network;
the fixed terminal comprises a third vehicle and peripheral device communication module; and the third vehicle and peripheral device communication module is used for receiving the first broadcast message, and sharing the running data sharing packet in the first broadcast message to the vehicular temporary network.

2. The system of claim 1, wherein the acquisition module comprises a camera and a first global positioning system sub-module;
the camera is used for shooting front road condition picture data as road condition data; and
the first global positioning system sub-module is used for acquiring current vehicle position data as road condition position data, and adding the road condition position data to the road condition data.

3. The system of claim 1, wherein the first vehicle terminal further comprises a radar detection module;
the radar detection module is used for detecting the front road condition in real time, detecting whether the current road condition accords with the sharing condition, and triggering the acquisition module to acquire road condition data when detecting that the current road condition accords with the sharing condition.

4. The system of claim 3, wherein the acquisition module further comprises a voice input sub-module;
the voice input sub-module is used for inputting voice data to generate road condition audio data, and adding the road condition audio data to the road condition data.

5. The system of claim 1, wherein the first terminal further comprises a first display;
wherein
the first processor is further used for adjusting running route information according to the road condition data to obtain adjusted running route information; and
the first display is used for displaying the road condition picture data and displaying the adjusted running route information.

6. The system of claim 1, further comprising a server, wherein the first vehicle terminal further comprises a first mobile communication module,
the first mobile communication module is used for generating network data according to the running data sharing packet, and uploading the network data to the server through a mobile network; and
the server is used for processing the road condition data, and feeding back the processing result to the first vehicle terminal, the second vehicle terminal and the fixed terminal.

7. The system of claim 1, wherein the second vehicle and peripheral device communication cation module is used for acquiring the running data sharing packet from the first broadcast message, generating a second broadcast message according to the running data sharing packet, and sharing the second broadcast message to the vehicular temporary network; and
the third vehicle and peripheral device communication module is further used for receiving the second broadcast message.

8. The system of claim 1, wherein
the third vehicle and peripheral device communication module is used for acquiring the running data sharing packet from the first broadcast message, generating a third broadcast message by adopting the running data sharing packet, and sharing the third broadcast message to the vehicular temporary network; and
the second vehicle and peripheral device communication module is further used for receiving the third broadcast message.

9. The system of claim 2, wherein the second vehicle terminal further comprises a second processor, a second global positioning system module and a second display;
the second global positioning system module is used for acquiring current vehicle position data;
the second processor is used for acquiring the road condition position data from the road condition data, marking the road condition position data and the current vehicle position data into map data to obtain front road information generated from the marked map data, acquiring current running route information, and adjusting the running route information according to the road condition position data to obtain adjusted running route information; and
the second display is used for displaying the marked map data and displaying the adjusted running route information.

10. A vehicle data processing method, comprising:
acquiring current road condition data by a first vehicle terminal when detecting that the current road condition accords with a sharing condition;
generating a running data sharing packet by adopting the road condition data, and sharing the running data sharing packet to a vehicular temporary network as a first broadcast message by the first vehicle terminal; and
sharing the miming data sharing packet by a fixed terminal and a second vehicle terminal which are connected to the vehicular temporary network after receiving the first broadcast message.

11. The method of claim 10, wherein acquiring current road condition data comprises:
the first vehicle terminal shooting front road condition image data, and acquiring current geographical position information as road condition position information; and
generating road condition data according to the road condition image data and the road condition position information.

12. The method of claim 10, further comprising:
the first vehicle terminal monitoring the front road condition in real time through a radar detection module, and judging whether the current road condition accords with the sharing condition.

13. The method of claim 12, further comprising:
the first vehicle terminal inputting voice data to generate road condition audio data, and adding the road condition audio data to the road condition data.

14. The method of claim 10, further comprising:
the first vehicle terminal adjusting running route information according to the road condition data to obtain adjusted running route information, and displaying the adjusted running route information.

15. The method of claim 10, further comprising:
the first vehicle terminal generating network data by adopting the running data sharing packet, uploading the network data to a server through a mobile network so that the server processes the road condition data, and receiving the processing result fed back by the server.

16. The method of claim 10, further comprising:
the second vehicle terminal acquiring current vehicle position data, and acquiring the road condition position data from the road condition data;
marking the road condition position data and the current vehicle position data into map data to obtain front road information generated from the marked map data; and
displaying the marked map data.

17. The method of claim 10, further comprising:
the second vehicle terminal acquiring current mining route information;
adjusting the running route information according to the road condition position data to obtain adjusted running route information; and
displaying the adjusted running route information.
